(19) United States
(12) Patent Application Publication
(10) Pub. No.: US 2024/0070073 A1
(43) Pub. Date: Feb. 29, 2024

(54) PAGE CACHE AND PREFETCH ENGINE FOR EXTERNAL MEMORY

(71) Applicant: Meta Platforms, Inc., Menlo Park, CA (US)

(72) Inventors: Hao Wang, Fremont, CA (US); Christian Markus Petersen, Golden, CO (US); Prakash Chauhan, Los Gatos, CA (US); Abhishek Dhanotia, Sunnyvale, CA (US); Shobhit O. Kanaujia, Santa Clara, CA (US)

(21) Appl. No.: 17/894,493

(22) Filed: Aug. 24, 2022

(51) Int. Cl. G06F 12/084; G06F 12/0882; G06F 13/42

(52) U.S. Cl. CPC G06F 12/084; G06F 12/0882; G06F 13/4221

(57) ABSTRACT

A system for accessing memory is disclosed. The system comprises a first communication interface configured to receive from an external processor a request for data. The system further comprises a second communication interface configured to communicate with an external memory module to provide the external processor indirect access to the data stored on the external memory module. The system further comprises a memory-side cache configured to cache the data obtained from the external memory module. The cache comprises a plurality of cache entries. The data obtained from the external memory is cached in one of the cache entries, and wherein the one of the cache entries comprises a plurality of cache data sectors with corresponding individual cache data sector valid status indicators and corresponding individual cache data sector modified status indicators and a common tag field for the plurality of cache data sectors.

### BACKGROUND OF THE INVENTION

Increasingly, a number of technologies generate a large amount of data. For example, social media websites, autonomous vehicles, the Internet of things, mobile phone applications, industrial equipment and sensors, and online and offline transactions all generate a massive amount of data. In some cases, cognitive computing and artificial intelligence are used to analyze these data. The result of these growing sources of data is an increased demand for memory and storage. Therefore, improved techniques for memory and storage are desirable.

### BRIEF DESCRIPTION OF THE DRAWINGS

Various embodiments of the invention are disclosed in the following detailed description and the accompanying drawings.

FIG. 1 illustrates that each processor 102 may connect to multiple memory channels 104.

FIG. 2 illustrates that each memory controller 202 has a memory channel 204, and each memory channel 204 may connect to multiple ranks 206.

FIG. 3 illustrates an example of a system 300 in which a processor 302 (e.g., a CPU or an accelerator) accesses CXL memory 308 (i.e., memory that is accessible via CXL) via a CXL memory expander module.

FIG. 4 illustrates a table 400 of the total latency under low system load (i.e., idle state latency) associated with native dynamic random-access memory (DRAM) memory and DRAM memory connected via CXL, respectively.

FIG. 5 illustrates another example of a system 500 in which a processor 302 (e.g., a CPU or an accelerator) accesses CXL memory 308 via a CXL memory expander module.

FIG. 6 illustrates an exemplary structure of a typical cache 600 of a CXL memory expander ASIC chip.

FIG. 7 illustrates an exemplary structure of an improved page cache 700 of a CXL memory expander ASIC chip.

FIG. 8 illustrates an exemplary structure of another improved page cache 800 of a CXL memory expander ASIC chip.

FIG. 9 illustrates an exemplary process 900 performed by prefetch engine 506.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Double Data Rate Synchronous Dynamic Random-Access Memory (DDR SDRAM) is a double data rate (DDR) synchronous dynamic random-access memory (SDRAM) class of memory integrated circuits used in computers. As dynamic random-access memory (DRAM) continues to increase in density and interface speeds continue to increase, the memory industry has gone through multiple generations, including the 1^{st} generation DDR1, 2^{nd} generation DDR2, 3^{rd} generation DDR3, 4^{th} generation DDR4, and 5^{th} generation DDR5 industry standards.

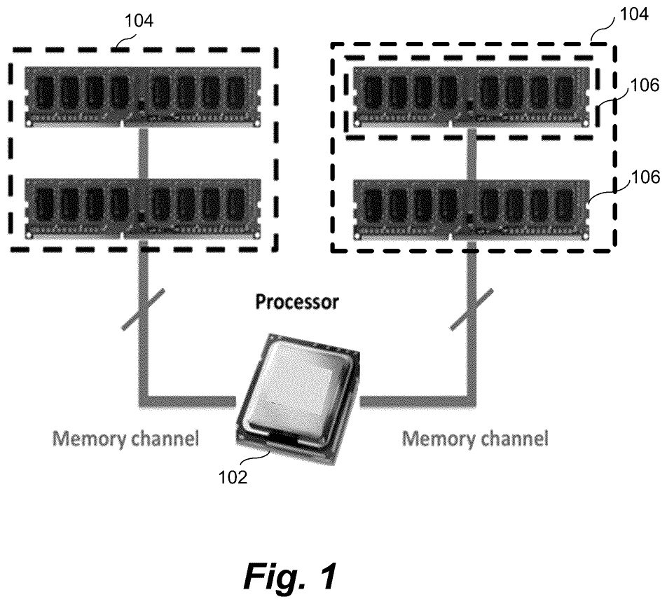

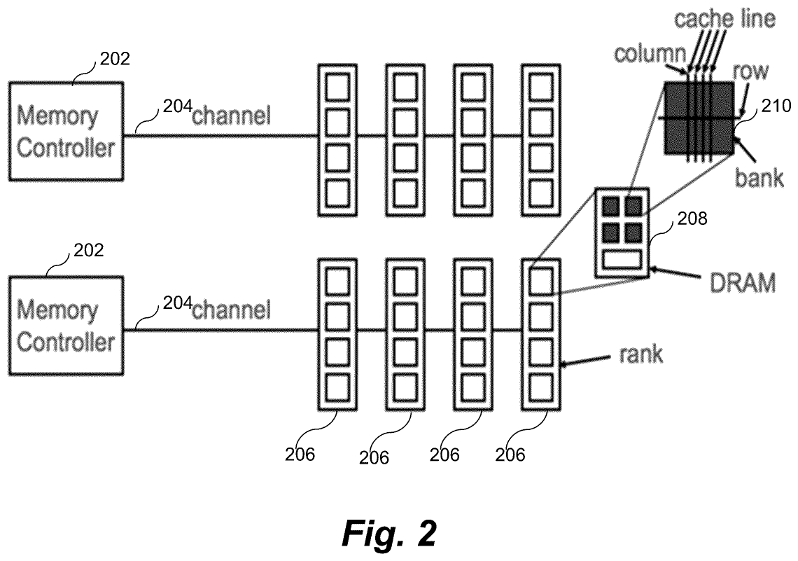

FIG. 1 illustrates that a processor 102 may connect to multiple memory channels 104. Each memory channel 104 may have multiple dual in-line memory modules (DIMMs) 106. FIG. 2 illustrates that each memory controller 202 has a memory channel 204, and each memory channel 204 may connect to multiple ranks 206. Each rank 206 has multiple dynamic random-access memory (DRAM) chips 208, and each DRAM chip 208 has multiple banks 210. Each rank 206 has multiple banks 210, e.g., 8 to 16 banks. Each bank 210 has a plurality of rows and columns and a plurality of cache lines. A bank is a logical concept in DRAM technology to represent a logical array of DRAM cells and can spread across multiple DRAM chips 208. When the processor reads or writes a cache block (64 byte), DRAM reads out the entire row of a bank into its row buffer internally, and the row of data is called a page in DRAM (a DRAM page).

A computer system utilizes integrated DDR memory controllers to connect a central processing unit (CPU) to memory. Traditionally, a CPU includes integrated memory controllers that implement a specific DDR technology. For example, the integrated memory controllers of a next-generation CPU may only support the use of DDR5 memory, but not the use of DDR4 memory at a lower cost.

To address this and other problems, the industry has designed a high performance I/O bus architecture known as the Compute Express Link (CXL). CXL may be used to interconnect peripheral devices that can be either traditional non-coherent I/O devices or accelerators with additional capabilities. CXL makes all the transactions on the bus that implements the CXL protocol coherent. CXL is an interconnect protocol that enables a new interface for adding memory to a system. The advantages include increased flexibility and reduced cost.

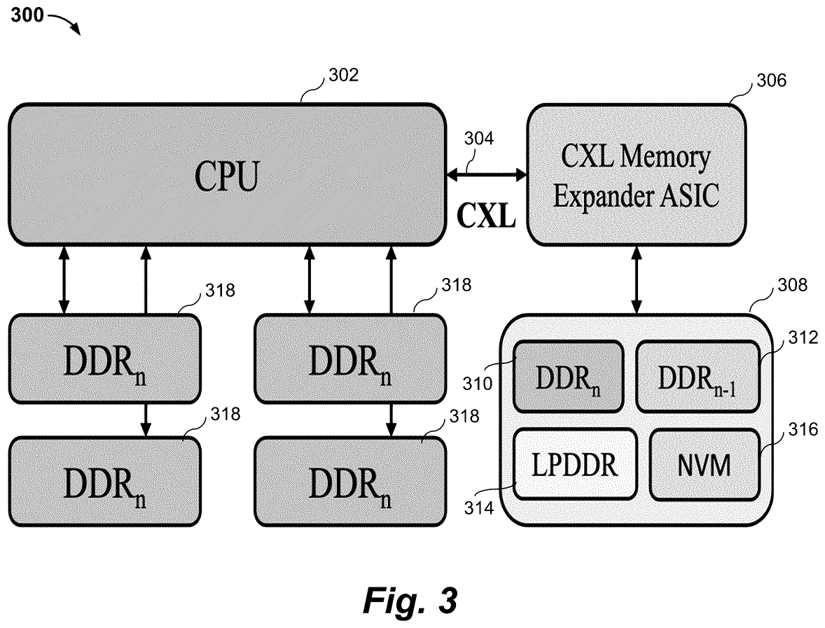

FIG. 3 illustrates an example of a system 300 in which a processor 302 (e.g., a CPU or an accelerator) accesses CXL memory 308 (i.e., memory that is accessible via CXL) via a CXL memory expander module. The CXL memory expander module may be a CXL memory expander application-specific integrated circuit (ASIC) chip 306. Examples of CXL memory 308 include low-power DDR SDRAM (LPDDR SDRAM) 314, different generations of DDR (e.g., DDRn 310 and DDRn-1312), and non-volatile memory (NVM) 316. As shown in FIG. 3, processor 302 communicates with the CXL memory expander ASIC chip 306 via a bus that implements the CXL protocol 304. Processor 302 may also access DDR memory 318 that are directly connected to processor 302.

Memory performance of a system includes three different aspects: capacity, bandwidth, and latency. The memory capacity is the amount of data (e.g., 16 gigabytes (GB) and 32 GB) the system may store at any given time in its memory. For capacity expansion, CXL provides a flexible way to add cheaper memory capacity. The bandwidth of the system is the sustained data read/write rate, e.g., 20 GB per second. Depending on the design choice, CXL memory's bandwidth may be either higher or lower.

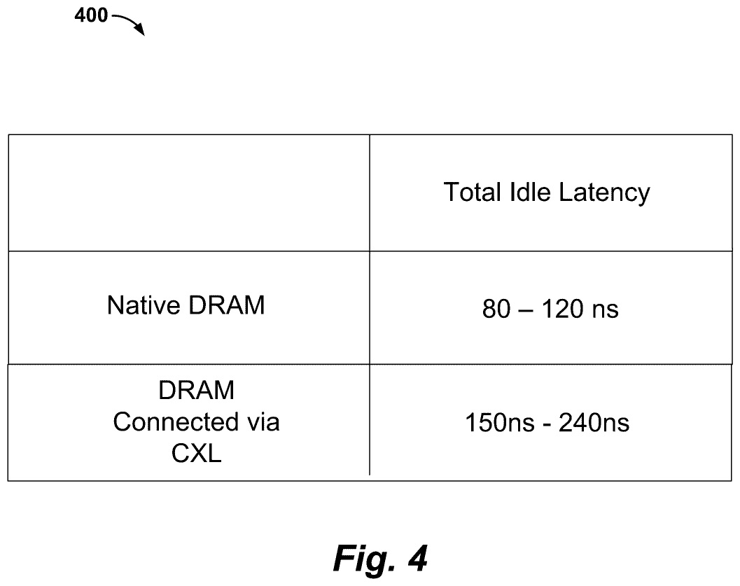

The latency of the system is the time from the processor requesting for a block of data until the response is received by the processor. CXL memory has longer access latency than native DDR memory (i.e., DDR memory that is directly connected to the CPU). FIG. 4 illustrates a table 400 of the total latency under low system load (i.e., idle state) associated with native DRAM memory and DRAM memory connected via CXL, respectively. As shown in table 400, the total idle latency associated with DRAM memory connected via CXL is about 70-120 ns greater than that associated with native DRAM memory. Note that the specific numbers in table 400 are projected based on a specific set of system configurations. The performance of applications and services running on CPUs is typically very sensitive to memory access latency. Without dedicated software and hardware optimizations, such extra latency will lead to lower system performance and higher infrastructure cost. Therefore, improved hardware optimizations to reduce the effective access latency of CXL memory would be desirable.

In the present application, a system for accessing memory is disclosed. The system comprises a first communication interface configured to receive from an external processor a request for data. The system further comprises a second communication interface configured to communicate with an external memory module to provide the external processor indirect access to the data stored on the external memory module. The system further comprises a memory-side cache configured to cache the data obtained from the external memory module. The cache comprises a plurality of cache entries. The data obtained from the external memory is cached in one of the cache entries, and wherein the one of the cache entries comprises a plurality of cache data sectors with corresponding individual cache data sector valid status indicators and corresponding individual cache data sector modified status indicators and a common tag field for the plurality of cache data sectors. For illustrative purposes only, the examples provided in the present application use the CXL open standard. However, it should be recognized that the improved techniques disclosed in the present application may use other standards or protocols as well.

A system for accessing memory is disclosed. A processor is configured to receive from an external processor a request for data. The processor is configured to communicate with an external memory module to provide the external processor indirect access to the data stored on the external memory module. The processor is configured to cache the data obtained from the external memory module in a memory-side cache. The memory-side cache comprises a plurality of cache entries, and wherein the data obtained from the external memory module is cached in one of the plurality of cache entries, and wherein the one of the plurality of cache entries comprises a plurality of cache data sectors with corresponding individual cache data sector valid status indicators and corresponding individual cache data sector modified status indicators and a common tag field for the plurality of cache data sectors. The system comprises a memory coupled to the processor and configured to provide the processor with instructions.

A method for accessing memory is disclosed. A request for data is received from an external processor. An external memory module is communicated with to provide the external processor indirect access to the data stored on the external memory module. The data obtained from the external memory module is cached in a memory-side cache. The memory-side cache comprises a plurality of cache entries, and wherein one of the plurality of cache entries is used to cache the data obtained from the external memory module, and wherein the one of the plurality of cache entries comprises a plurality of cache data sectors with corresponding individual cache data sector valid status indicators and corresponding individual cache data sector modified status indicators and a common tag field for the plurality of cache data sectors.

In some embodiments, the improved techniques disclosed in the present application may be applied for memory expansion connected via CXL interfaces. In some embodiments, the improved techniques disclosed in the present application may be applied for memory expansion connected via any die-to-die or chip-to-chip coherent interconnect technologies, including Cache Coherent Interconnect for Accelerators (CCIX), Open Coherent Accelerator Processor Interface (OpenCAPI), and Universal Chiplet Interconnect Express (UCIe). In some embodiments, the improved techniques in the present application may be applied to lower-tier memory in a multi-tier memory system. The lower tier memory refers to a memory region that has longer access latency than the top-tier memory, which can have its controller residing either in or outside of the processor chip.

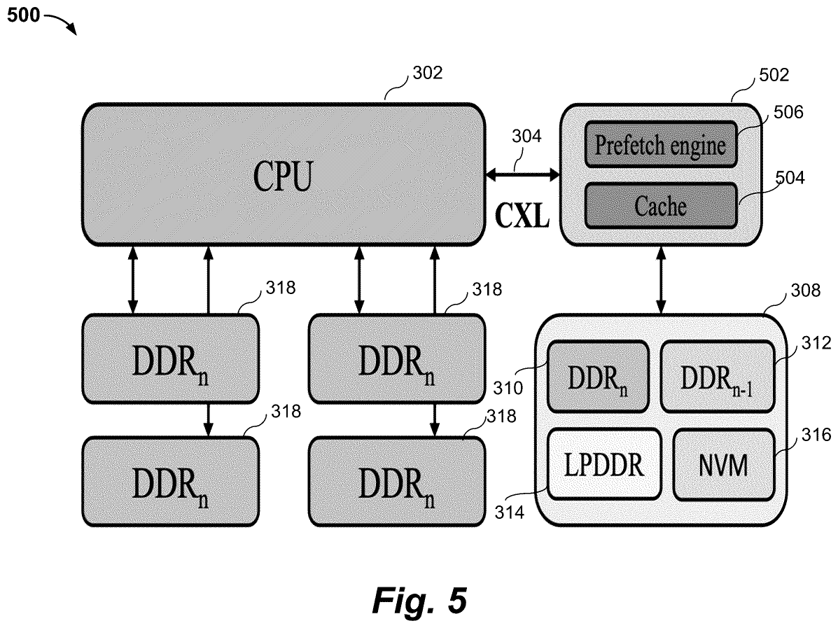

FIG. 5 illustrates another example of a system 500 in which a processor 302 (e.g., a CPU or an accelerator) accesses CXL memory 308 via a CXL memory expander module. The CXL memory expander module may be a CXL memory expander application-specific integrated circuit (ASIC) chip 502. Examples of CXL memory 308 include low-power DDR SDRAM (LPDDR SDRAM) 314, different generations of DDR (e.g., DDRn 310 and DDRn-1 312), and non-volatile memory (NVM) 316. CXL memory expander ASIC chip 502 includes one or more communication interfaces configured to communicate with the external CXL memory 308 to provide the external processor 302 indirect access to the data stored on the external CXL memory 308. As shown in FIG. 5, processor 302 communicates with the CXL memory expander ASIC chip 502 via a bus that implements the CXL protocol 304. CXL memory expander ASIC chip 502 includes one or more communication interfaces configured to receive requests for data from processor 302 that is external to the ASIC chip. The one or more communication interfaces are connected to processor 302 via the bus that implements the CXL protocol 304. Processor 302 may also access DDR memory 318 that are directly connected to processor 302.

CXL memory expander ASIC chip 502 includes a cache 504 and a prefetch engine 506. Cache 504 is a memory-side cache configured to cache the data obtained from the external CXL memory 308. The cache 504 comprises a plurality of cache entries. Cache 504 buffers the data that is recently read from CXL memory 308 and/or about to be written into CXL memory 308. Prefetch engine 506 determines what additional data to read from CXL memory and when to read them. Prefetch engine 506 is configured to fetch the data and additional data obtained from the external CXL memory 308 and cached into cache 504. The resource organization and operating mechanism of cache 504 and prefetch engine 506 have many advantages and are very different than those found in existing processors, including CPUs and graphics processing units (GPUs), as will be described in greater detail below.

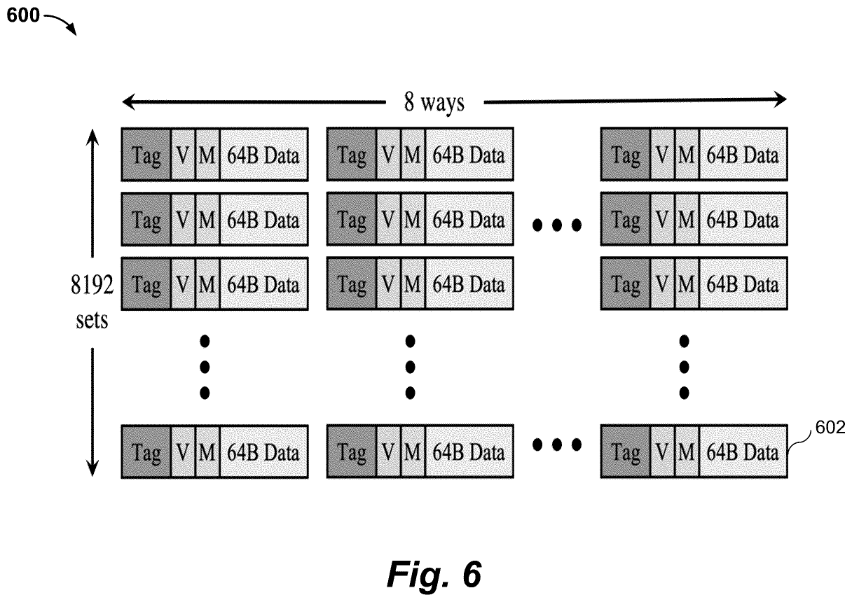

FIG. 6 illustrates an exemplary structure of a typical cache 600 of a CXL memory expander ASIC chip. Cache 600 includes a plurality of cache entries 602, and each cache entry 602 at least includes a tag, a valid (V) bit, a modified (M) bit, and a 64-byte data block. The tag uniquely identifies a cache block. The valid (V) bit indicates that the cache entry has valid data. The modified (M) bit indicates that the data has been modified and therefore needs to be written back to memory. In some embodiments, the cache entries are arranged in an 8×8192 array, with 8 ways in one dimension and 8192 sets in another dimension.

In some embodiments, each 64-byte data block in a cache entry 602 is managed independently. Spatial locality is explored within a 64-byte data block, as larger blocks may waste memory bandwidth and reduce cache utilization. Temporal locality is explored by keeping the hot cache entry in each set longer.

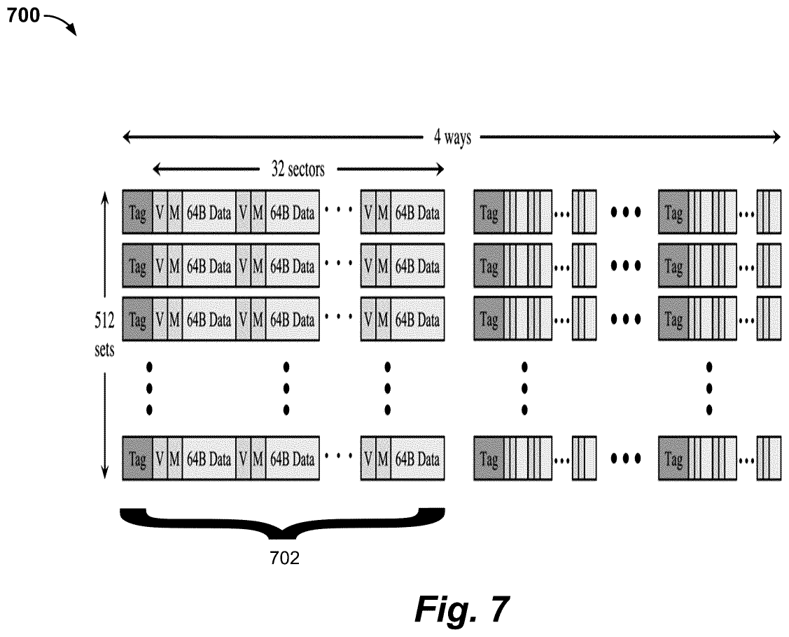

FIG. 7 illustrates an exemplary structure of an improved page cache 700 of a CXL memory expander ASIC chip. In this embodiment, the total cache capacity in page cache 700 is the same as that in cache 600. Cache 700 includes a plurality of cache entries 702, and each cache entry 702 includes a page of data. It should be recognized that the page size (also referred to as the cache entry size) does not necessarily match the DRAM page size (or the row buffer size) of the CXL memory. For example, the page size may be ¼, ½, 1, or 2 times (2λ) the row buffer size. In cache 700, the page size is 64 bytes*32 sectors=2048 bytes=2 kilobyte (kB), which is ¼ of the typical 8 KB DRAM page size. In some embodiments, the page size is determined based on the DRAM page size. For example, the page size is the DRAM page size scaled by a predetermined scale factor. In some embodiments, the page size is at least or greater than one kilobytes (1 kB).

Cache 700 operates as a page cache. Matching the page size to the Operating System (OS) page helps with the preparation for an upcoming OS page migration. Having the page size on the same order of the DRAM page effectively increases the number of DRAM pages that are open. A DRAM page is open means a row is read out in the row buffer, which can service a memory access request with lower latency and energy consumption. However, the page size does not need to match the exact size of either an OS page (e.g., 4 kB) or a DRAM page (e.g., 1 kB-16 KB).

Each cache entry 702 has only a single tag to identify the page of data, but each 64-byte sector still has its own valid (V) bit and its own modified (M) bit. A cache entry 702 comprises a plurality of cache data sectors with corresponding individual cache data sector valid status indicators (i.e., the V bits of the 64-byte cache data sectors) and corresponding individual cache data sector modified status indicators (i.e., the M bits of the 64-byte cache data sectors) and a common tag field for the plurality of cache data sectors. In the example in FIG. 7, each cache entry 702 has 32 sectors of 64 bytes, and each may be read from and/or written into CXL memory independently. In this embodiment, the cache entries are arranged in a 4×512 array, with 4 ways in one dimension and 512 sets in another dimension. The key design philosophy focuses on spatial locality mainly, but not temporal locality. Page cache 700 is used as an extended pool of DRAM page/row buffers.

When a read request from processor 302 is received by CXL memory expander ASIC chip 502, a lookup is performed by CXL memory expander ASIC chip 502 by finding a set based on an indexing mechanism. After the set is found, tag matching is performed based on the tags that identify their corresponding pages of data. When there is a cache miss, the requested data is retrieved from CXL memory 308. A new cache entry is allocated, and the requested data is stored as a sector in the new cache entry with a valid bit set to 1. The valid bits of the remaining sectors in the new cache entry are reset to 0. A replacement mechanism (e.g., the Least Recently Used (LRU) mechanism) may be used to find a victim cache entry. The Least Recently Used (LRU) cache is a cache eviction algorithm that organizes elements in order of use. In LRU, the element that has not been used for the longest time will be evicted from the cache. When a write request from processor 302 is received by CXL memory expander ASIC chip 502, a machine-specific register may be used to configure the option to skip allocating cache entry but writing into CXL memory directly.

Typically, a prefetch engine tracks and learns the memory access pattern to predict future memory access. In addition, prefetch engine 506 of CXL memory expander application-specific integrated circuit (ASIC) chip 502 prefetches data based on knowledge of specific access behaviors to CXL memory.

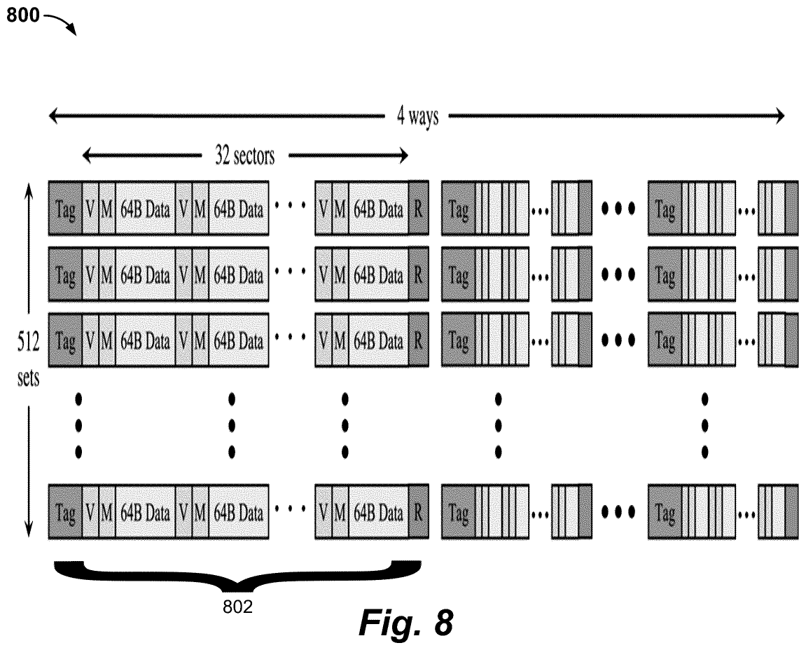

FIG. 8 illustrates an exemplary structure of another improved page cache 800 of a CXL memory expander ASIC chip 502. Page cache 800 is similar to page cache 700. One difference between page cache 800 and page cache 700 is that each cache entry 802 includes an additional entry hit counter R, as will be described in greater detail below.

In this embodiment, the total cache capacity in page cache 800 is the same as those in cache 600 and cache 700. Cache 800 includes a plurality of cache entries 802, and each cache entry 802 includes a page of data. It should be recognized that the page size does not necessarily match the DRAM page size (or the row buffer size) of the CXL memory. For example, the page size may be ¼, ½, 1, or 2 times (2λ) of the row buffer size. In cache 800, the page size is 64 bytes*32 sectors=2048 bytes=2 kilobyte (kB), which is ¼ of the typical 8 KB DRAM page size. In some embodiments, the page size is at least or greater than 1 kB.

Each cache entry 802 has only a single tag to identify the page of data, but each 64-byte sector still has its own valid (V) bit and its own modified (M) bit. In other words, each cache entry 802 has 32 sectors of 64 bytes, and each may be read from and/or written into CXL memory independently. In this embodiment, the cache entries are arranged in a 4×512 array, with 4 ways in one dimension and 512 sets in another dimension.

Each cache entry 802 has an additional N-bit cache entry hit counter R. In some embodiments, N=2. The N-bit cache entry hit counter R counts the number of times the entry is hit by a read request from the CPU. The N-bit cache entry hit counter R increments when its corresponding cache entry is hit by a read request. Based on the value of counter R, prefetch engine 506 generates prefetch requests to fetch one or more 64-byte sectors in a specific prefetch chunk size.

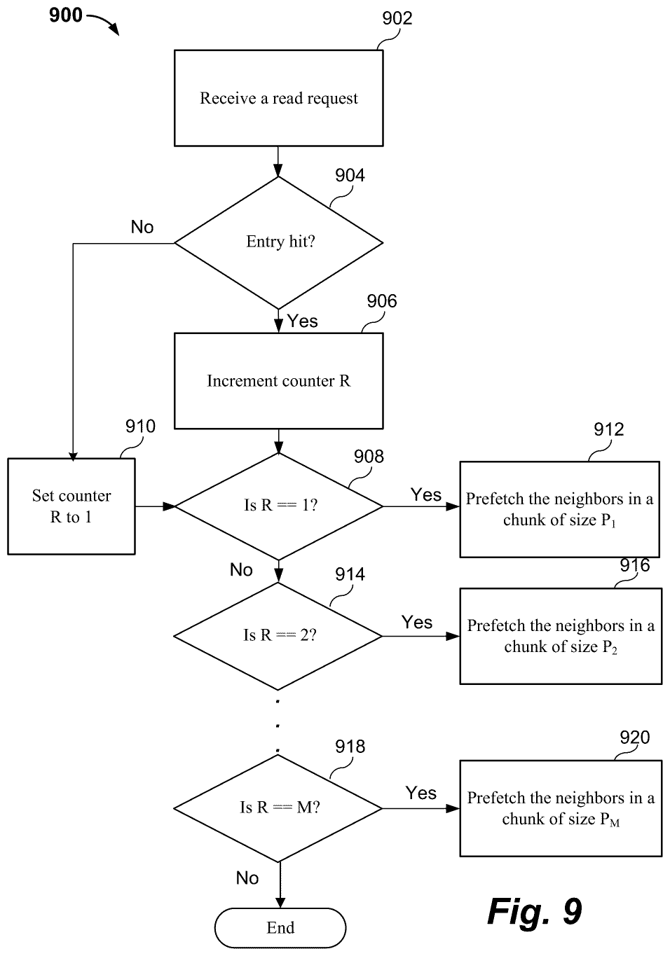

FIG. 9 illustrates an exemplary process 900 performed by prefetch engine 506. At 902, a read request from processor 302 is received by CXL memory expander ASIC chip 502. At 904, it is determined whether there is a cache entry hit. If there is a cache entry hit, then at step 906, cache entry hit counter R is incremented. Otherwise, at step 910, cache entry hit counter R is reset to 1 along with allocating a new cache entry as described above as part of the cache operations. At step 908, it is determined whether R is equal to 1. If R is equal to 1, then at step 912, the requested data and its neighbors in a predetermined prefetch chunk size of P₁ are fetched by prefetch engine 506. Otherwise, process 900 proceeds to step 914. At step 914, it is determined whether R is equal to 2. If R is equal to 2, then at step 916, the requested data and its neighbors in a predetermined prefetch chunk size of P₂ are fetched by prefetch engine 506. Otherwise, process 900 proceeds to other steps (not shown in FIG. 9) to determine whether R is equal to other values. Finally, at step 918, it is determined whether R is equal to M. If R is equal to M, then at step 920, the requested data and its neighbors in a predetermined prefetch chunk size of PM are fetched by prefetch engine 506. Otherwise, process 900 reaches the end of the process and is terminated.

In some embodiments, the prefetch chunk size (e.g., P₁, P₂, and PM) may be predetermined based on different criteria and may be dynamically configured by writing into machine-specific registers (MSRs).

For example, for CXL-capacity expansion, P₁ may be configured to 128 bytes. When P₁=128 bytes, one 64-byte sector neighboring the sector including the requested data plus the sector including the requested data are fetched from CXL memory in a 128-byte chunk. The method to determine which neighboring 64-byte sector to fetch may be based on different criteria. For example, the selected neighbor is the neighboring 64-byte sector to the left or right of the sector including the requested data. P₂ may be configured to be the number of sectors in a cache entry * the number of bytes in each sector, because a page migration will likely occur. In other words, P₂=32 sectors * 64 bytes=2048 bytes (as shown in page cache 800 in FIG. 8), such that all the 64-byte sectors in a cache entry 802 are filled by the fetched data chunk. In this example, the chunk size increases with the value of the cache entry hit counter.

In another example, for CXL-bandwidth expansion, the goal is to maximize DRAM efficiency. P₁ may be configured to be the number of consecutive 64-byte sectors in a DRAM bank, such that all consecutive data that are already read out from the DRAM array are fetched, thereby maximizing the bandwidth efficiency. For example, with a typical DRAM address interleaving policy, the number of consecutive 64-byte sectors in a DRAM bank is four. Therefore, P₁=4 * 64 bytes=256 bytes. In some embodiments, the address interleaving policy may be co-designed with the cache organization.

To determine the number of consecutive 64-byte sectors in a DRAM bank, an example is provided below. In this example, there are 1024 blocks of data that are numbered from 0-1023 to form a 1024 blocks * 64 bytes=64 kB memory system. The data is stored in two channels, with 16 banks in each channel. In other words, the data is stored in 2 channels * 16 banks=32 buckets or banks. An address mapping or memory interleaving scheme may be used to determine which bucket/bank (e.g., bank Y of channel Z) should be used to store a particular block of data (e.g., block X).

In one illustrative example, the mapping/interleaving scheme in which four consecutive blocks/sectors are stored in the same bank is as follows:
Block 0-3 is stored in bank 0 of channel 0
Block 4-7 is stored in bank 0 of channel 1
Block 8-11 is stored in bank 1 of channel 0
Block 12-15 is stored in bank 1 of channel 1

In some embodiments, the selected cache entry size depends on the memory address interleaving granularity, and vice versa In one example, the cache entry size is 1 KB, and the interleaving granularity is set to 1 kB or larger, such that an open page has all the data needed to fill the cache entry. In another example, with 256 bytes of interleaving, a contiguous 1 KB of data will span over 4 banks (hence 4 pages).

In some embodiments, cache access statistics collected by CXL memory expander application-specific integrated circuit (ASIC) chip 502 may be sent to the operating system for improved performance. Currently, software mechanisms to measure OS page access frequency is coarse-grained and inaccurate. For example, within a short time interval (e.g., 1 minute), software mechanisms cannot determine whether an OS page is accessed once or a hundred times In contrast, the cache access statistics collected by CXL memory expander application-specific integrated circuit (ASIC) chip 502 may provide more fine-grained OS page access frequency information, which allows the operating system to make better decisions in OS page placement. In some embodiments, a high cache hit rate for an OS page may be sent as a feedback to the operating system for suppressing a page migration decision. The rationale is that having a high cache hit rate means that the access latency is low, even when the data is stored in the lower-tier CXL memory.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a first communication interface configured to receive from an external processor a request for data;
a second communication interface configured to communicate with an external memory module to provide the external processor indirect access to the data stored on the external memory module; and
a memory-side cache configured to cache the data obtained from the external memory module, wherein the memory-side cache comprises:
a plurality of cache entries, and wherein the data obtained from the external memory module is cached in one of the plurality of cache entries, and wherein the one of the plurality of cache entries comprises a plurality of cache data sectors with corresponding individual cache data sector valid status indicators and corresponding individual cache data sector modified status indicators and a common tag field for the plurality of cache data sectors.

2. The system of claim 1, wherein the first communication interface is connected to the external processor via a bus that implements the Compute Express Link (CXL) protocol.

3. The system of claim 1, wherein the external memory module comprises one or more of the following: low-power DDR SDRAM (LPDDR SDRAM), Double Data Rate Synchronous Dynamic Random-Access Memory (DDR SDRAM), and non-volatile memory (NVM).

4. The system of claim 1, wherein the common tag field for the plurality of cache data sectors identifies the plurality of cache data sectors.

5. The system of claim 1, wherein one of the corresponding individual cache data sector valid status indicators indicates that an individual cache data sector includes valid data.

6. The system of claim 1, wherein one of the corresponding individual cache data sector modified status indicators indicates that an individual cache data sector includes data that has been modified.

7. The system of claim 1, wherein the plurality of cache data sectors of the one of the plurality of cache entries comprises a cache entry hit counter, and wherein the cache entry hit counter counts a number of times the one of the plurality of cache entries is hit by a request for data from the external processor.

8. The system of claim 7, further comprising a prefetch engine configured to fetch the data and additional data obtained from the external memory module and cache into the memory-side cache.

9. The system of claim 8, wherein the data and the additional data have a chunk size that is determined based at least in part on a value of the cache entry hit counter.

10. The system of claim 9, wherein the chunk size increases with the value of the cache entry hit counter.

11. The system of claim 9, wherein the chunk size is a number of consecutive sectors in a dynamic random-access memory (DRAM) bank.

12. The system of claim 1, wherein the plurality of cache entries has a size greater than one kilobytes.

13. The system of claim 1, wherein the plurality of cache entries has a size that is determined by scaling a dynamic random-access memory (DRAM) page size by a predetermined scale factor.

14. The system of claim 1, wherein the memory-side cache is configured to collect cache access statistics and send the collected cache access statistics to an operating system associated with the external processor, wherein the collected cache access statistics are used by the operating system for making page migration decisions.

15. A system, comprising:
a processor configured to:
receive from an external processor a request for data;
communicate with an external memory module to provide the external processor indirect access to the data stored on the external memory module; and
cache the data obtained from the external memory module in a memory-side cache, wherein the memory-side cache comprises:
a plurality of cache entries, and wherein the data obtained from the external memory module is cached in one of the plurality of cache entries, and wherein the one of the plurality of cache entries comprises a plurality of cache data sectors with corresponding individual cache data sector valid status indicators and corresponding individual cache data sector modified status indicators and a common tag field for the plurality of cache data sectors; and
a memory coupled to the processor and configured to provide the processor with instructions.

16. The system of claim 15, wherein the common tag field for the plurality of cache data sectors identifies the plurality of cache data sectors.

17. The system of claim 15, wherein the plurality of cache data sectors of the one of the plurality of cache entries comprises a cache entry hit counter, and wherein the cache entry hit counter counts a number of times the one of the plurality of cache entries is hit by a request for data from the external processor.

18. A method, comprising:
receiving from an external processor a request for data;
communicating with an external memory module to provide the external processor indirect access to the data stored on the external memory module; and
caching the data obtained from the external memory module in a memory-side cache, wherein the memory-side cache comprises:
a plurality of cache entries, and wherein one of the plurality of cache entries is used to cache the data obtained from the external memory module, and wherein the one of the plurality of cache entries comprises a plurality of cache data sectors with corresponding individual cache data sector valid status indicators and corresponding individual cache data sector modified status indicators and a common tag field for the plurality of cache data sectors.

19. The method of claim 18, wherein the common tag field for the plurality of cache data sectors identifies the plurality of cache data sectors.

20. The method of claim 18, wherein the plurality of cache data sectors of the one of the plurality of cache entries comprises a cache entry hit counter, and wherein the cache entry hit counter counts a number of times the one of the plurality of cache entries is hit by a request for data from the external processor.
